(19) United States
(12) Patent Application Publication
(10) Pub. No.: US 2005/0066059 A1
(43) Pub. Date: Mar. 24, 2005

(54) Propagating attributes between entities in correlated namespaces

(76) Inventors: John H. Zybura, Seattle, WA (US); Max L. Benson, Redmond, WA (US); Herman Man, Issaquah, WA (US); Edward H. Wayt, Seattle, WA (US); Felix W. Wong, Bellevue, WA (US); Jing Wu, Sammamish, WA (US)

Correspondence Address: LEE & HAYES PLLC, 421 W RIVERSIDE AVENUE SUITE 500, SPOKANE, WA, 99201, US

(21) Appl. No.: 10/671,408

(22) Filed: Sep. 24, 2003

(51) Int. Cl. G06F 15/16; G06F 17/30

(52) U.S. Cl. 709/248; 707/203

(57) ABSTRACT

Changes to references are propagated between entities in correlated namespaces. A first object in one external namespace refers to a second object in the one external namespace. The first object and the second object have associated central representations in a central namespace. A change to that reference is propagated to a third object in a third namespace by evaluating the associations between the central representations in the central namespace to determine if the third object is associated with one of the central representations, and if so, propagating the change to the reference. A user interface for configuring the flow of the propagations is also described.

### TECHNICAL FIELD

This application relates generally to synchronization of information and more specifically to synchronization of information in a plurality of information structures or hierarchies.

### BACKGROUND OF THE INVENTION

Often a company stores important information in various data sources. For example, a human resources department may store information about employees in a human resources data source. The human resources data source may be arranged or organized according to a human resources specific information structure or hierarchy. A finance department may also store information about employees, clients, suppliers, etc., in a finance department data source. The finance department data source may be arranged or organized according to a finance department information structure or hierarchy. It is likely that some common information exists in both data sources. Thus, synchronizing the information becomes desirable.

A synchronizing process typically implements rules and/or specifications to adequately harmonize information in various data sources. Further, such a process may rely on an engine capable of executing software and a storage capable of storing the information, as appropriate. In general, the synchronizing process may replicate information from various data sources in a central storage, wherein the replicated information has some degree of integrity. To achieve this task, information from the various data sources are either pushed or pulled into the central storage. In addition, information may be pulled or pushed out of such a central storage to the various data sources. Maintaining efficiency and information integrity in such an environment can become a daunting task. Various exemplary methods, devices and/or systems described below are directed at that task.

### SUMMARY OF THE INVENTION

Briefly stated, modifications to references are propagated between entities in correlated namespaces. A first object in one external namespace refers to a second object in the one external namespace. The first object and the second object have associated central representations in a central namespace. A change to that reference is propagated to a third object in a third namespace by evaluating the associations between the central representations in the central namespace to determine if the third object is associated with one of the central representations, and if so, propagating the change to the reference.

In another aspect, a user interface is described that allows a user of a system to define relationships that govern the flow of data from one namespace to another. The user interface may be graphical, and include fields that allow the user to identify source and target entities and the direction of the flow of data. Configuration information describing the defined relationships may be stored in conjunction with each namespace the configuration information may take the form of a markup language file, and more specifically an eXtensible Markup Language file.

In yet another aspect, a technique is described for propagating a reference change from a first object in a first namespace to a related second object in another namespace by correlating the first object to a central representation, identifying another central representation, if any, corresponding to the referent of the reference, and identifying any other objects associated with the other central representation. Any such other objects that depend on data stored in association with the other central representation then receive that data. The data may be reformatted or otherwise reconstituted.

In still another aspect, a technique is described for propagating a name change of a referent in a reference field of a first object in a first namespace to a related second object in a second namespace by correlating the referent to a central representation of the referent, identifying any other objects associated with that central representation, and propagating the name change to those other objects. The correlation of the referent to its central representation is performed using an immutable property of the referent, such as a globally unique identifier.

### BRIEF DESCRIPTION OF THE DRAWINGS

FIG. 1 is a functional block diagram generally illustrating an exemplary system that includes a metadirectory and a plurality of data sources.

FIG. 2 is a functional block diagram illustrating in slightly greater detail the storage of the metadirectory of FIG. 1 as it interacts with various data sources

FIG. 3 is a functional block diagram generally illustrating information that is included in an “entity” as that term is used in this document.

FIG. 4 is a functional block diagram generally illustrating a pair of entities each stored in a different data source, and their corresponding central entity stored in the metadirectory.

FIG. 5 is a graphical representation of one illustrative join table that may be included in some implementations of the present invention

FIGS. 6 and 7 are illustrative screen shots illustrating a graphical user interface that may be employed to create rules to govern the master/slave relationships described in conjunction with FIG. 4.

FIG. 8 is a sample of XML code that may be generated by the user interface of FIG. 6.

FIG. 9 is a sample of XML code that may be generated by the user interface of FIG. 7.

FIG. 10 is a logical flow diagram generally illustrating steps performed by a process for propagating a change to a reference attribute in one data source to another data source in a metadirectory environment

FIG. 11 is a logical flow diagram generally illustrating steps of a process for propagating a name change of a referent in a reference attribute

FIG. 12 shows an exemplary computer suitable as an environment for practicing various aspects of subject matter disclosed herein

### DETAILED DESCRIPTION

The following description sets forth a specific embodiment of a system for propagating information between entities in correlated namespaces. This specific embodiment incorporates elements recited in the appended claims. The embodiment is described with specificity in order to meet statutory requirements. However, the description itself is not intended to limit the scope of this patent. Rather, the inventors have contemplated that the claimed invention might also be embodied in other ways, to include different elements or combinations of elements similar to the ones described in this document, in conjunction with other present or future technologies.

The following discussion refers to an information environment that includes a metadirectory. While a metadirectory is used here for explanatory purposes, the various mechanisms and methods described here may also be applied generally to other environments where synchronization of information is desired. In general, information should be identifiable in an information environment, for example, through use of an identifier, and preferably an immutable or traceable identifier. In some instances, information is structured or organized in a hierarchy.

Exemplary Metadirectory System

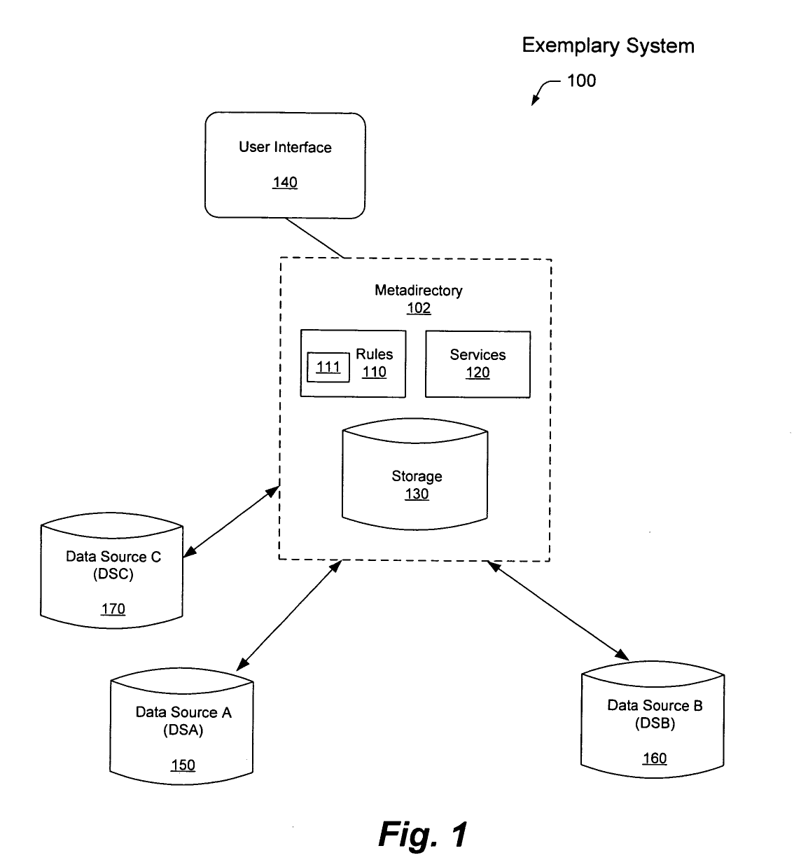

FIG. 1 shows an exemplary system 100 that includes an exemplary metadirectory 102 capable of communicating information to and/or from a plurality of data sources (e.g., DSA 150, DSB 160, and DSC 170). Each data source includes many objects, with each object containing information. For this discussion, each object may be thought of as a body of information, such as information about an individual (e.g., name, address, salary), a mailing list (members), an e-mail account (e-mail address), a corporate asset (serial number), or the like. For example if DSA 150 were a human resources database, then objects within DSA 150 may correspond to employees, and each employee may have characteristics such as an employee number, a manager, an office location, and the like.

There may also be an object in another data source that pertains to the same body of information, but includes slightly different characteristics or information. For example, DSB 160 may be an information technology server that includes information about the logon accounts of employees. Accordingly, there may be a corresponding object within DSB 160 for each or many of the objects in DSA 150. However, the particular body of information for the objects within DSB 160 would be slightly different than those within DSA 150. Collectively, the information associated with a particular body of information are sometimes referred to as “identity data” or the like.

The metadirectory 102 is an infrastructure element that provides an aggregation and clearinghouse of the information stored within each of the several data sources associated with the metadirectory 102. The metadirectory 102 includes storage 130 in which reside “entities” that represent the individual bodies of information stored in each associated data source. Disparate information from different data sources that pertains to the same body of information (e.g., an individual, asset, or the like) is aggregated into a single entity within the metadirectory 102. In this way, a user can take advantage of the metadirectory 102 to view at a single location information that is stored piecemeal in several different data sources. Such an exemplary metadirectory may consolidate information contained in multiple data sources in a centralized manner, manage relationships between the data sources, and allow for information to flow between them as appropriate.

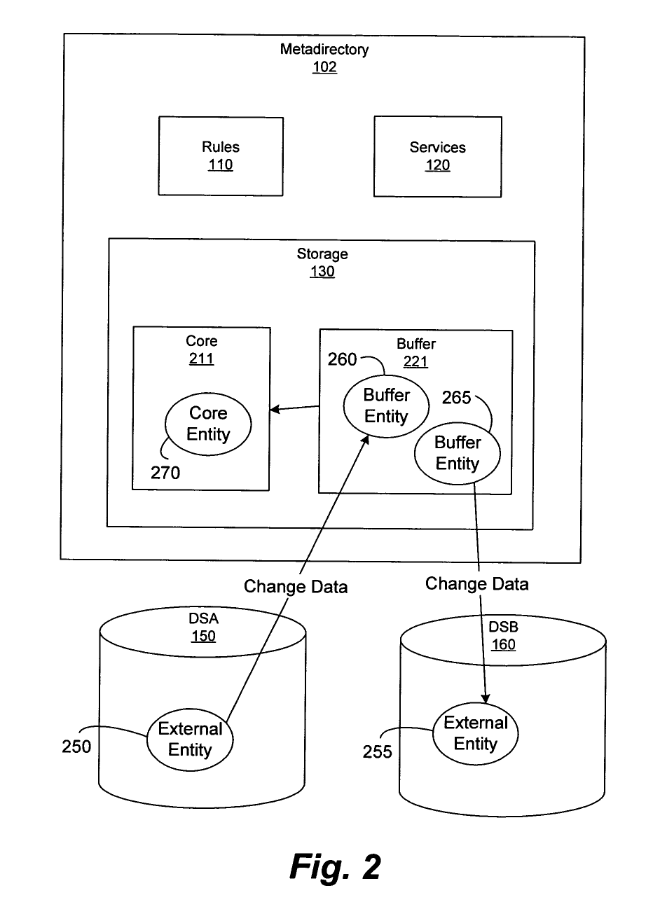

The storage 130 is for storing the aggregated and consolidated information from each of the associated data sources. The storage 130 may be a database or any other mechanism for persisting data in a substantially permanent manner. As will be described more fully in conjunction with FIG. 2, the storage 130 may include core storage (sometimes referred to as a “metaverse”), in which the data is deemed to be valid, and transient storage (e.g., a buffer or connector space) used to temporarily store information awaiting inclusion in the core storage. In other words, changes, additions, or deletions to information in one or more data sources may be presented to the metadirectory 102 and temporarily stored in a buffer until they can be committed to the core storage.

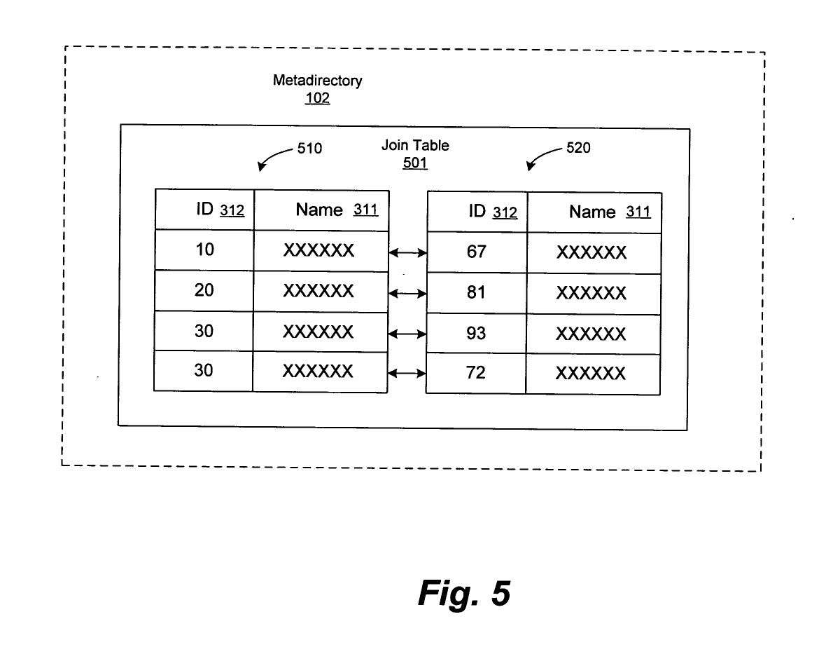

The metadirectory 102 also includes rules 110 and services 120 that are used to consolidate, synchronize, and otherwise maintain the integrity of the information presented through the metadirectory 102. The rules 110 and services 120 form or define one or more protocols, APIs, schemata, services, hierarchies, etc. In this particular embodiment, the rules 110 include at least a “join function” that defines relationships between entities in the metadirectory 102 and objects in the associated data sources. In one embodiment, the join function may produce a join table 111 that identifies links between entities in the storage and objects in each associated data source. One illustrative join table 111 is described in greater detail below in conjunction with FIG. 5.

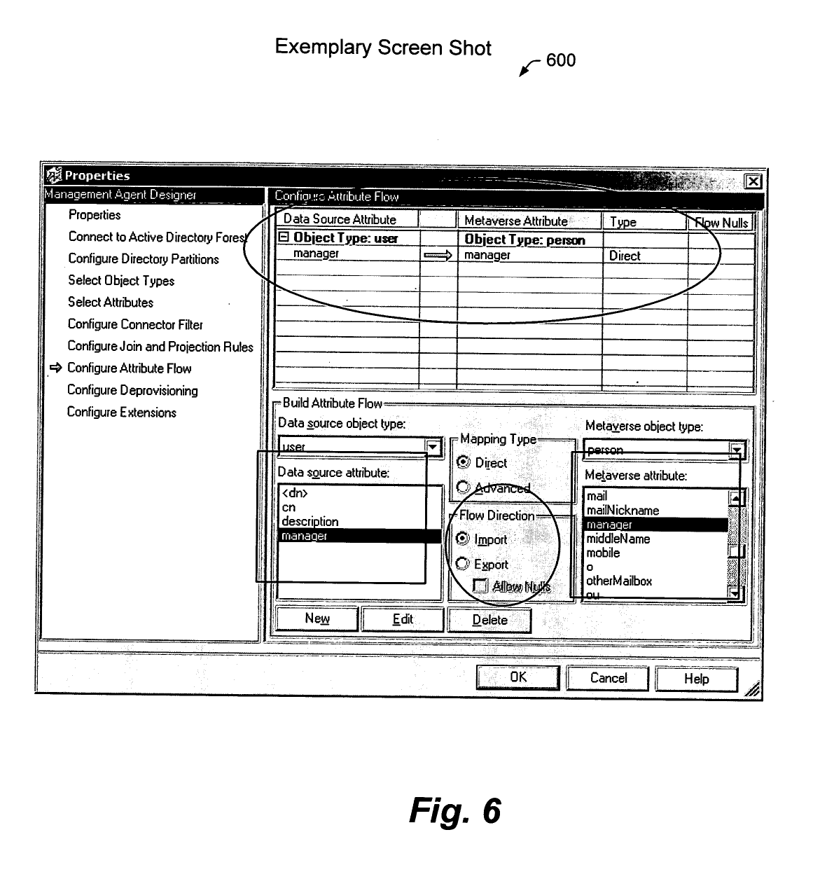

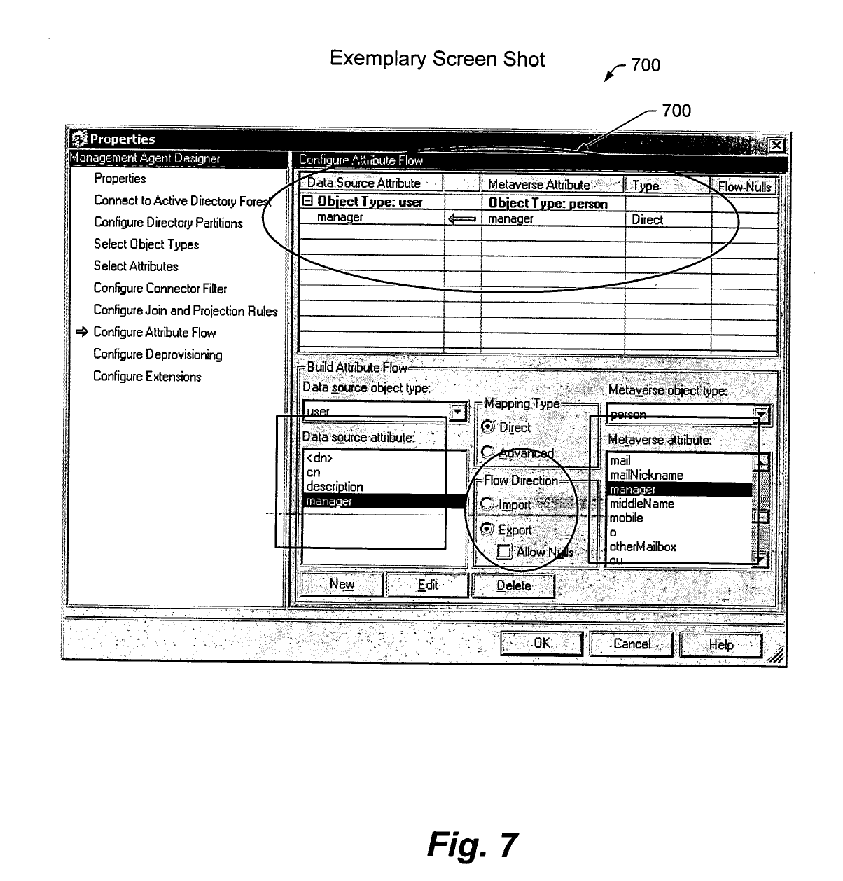

A user interface 140 is provided that allows a user (e.g., a system administrator) to view and manipulate information within the metadirectory 102, the configuration of the metadirectory 102, or both. In this particular embodiment, the user interface 140 is graphical in nature and is configured to, among other things, enable the user to declaratively define relationships between entities or their attributes in the several data sources. One illustrative embodiment of the user interface is described below in conjunction with FIGS. 6 and 7. Briefly stated, the user interface 140 allows a user to identify a “master” data source for each attribute of an entity within the metadirectory 102. The user input from the user interface 140 may be stored within the table 111 for later use during synchronization or the like.

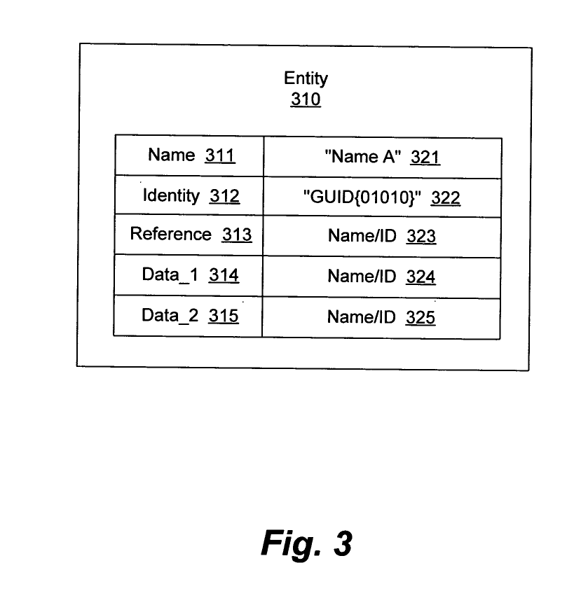

FIG. 2 is a functional block diagram illustrating in slightly greater detail the storage 130 of the metadirectory 102 as it interacts with the various data sources. The data stored within the system are termed “entities” for the purpose of this discussion (e.g., core entity 270, buffer entity 260, external entity 250). Generally stated, entities are objects that include any arbitrary collection of data (e.g., current values, change information, etc.) about the bodies of information that reside in the various data sources. Entities within the metadirectory 102 may be referred to collectively as “central entities,” and entities outside the metadirectory 102 may be referred to collectively as “external entities.” For example, a central entity within the metadirectory 102 may correspond to two or more external entities and include an aggregation of the information stored in each of the corresponding external entities. More specific detail about entities and their relationships is provided below in conjunction with FIG. 3.

As mentioned above, the storage 130 may include a core 211 and a buffer 221. The core 211 represents data that is considered to accurately reflect (from the perspective of a user of the metadirectory 102) the information in the various data sources. In contrast, the buffer 221 includes data of a more transient nature. Recent changes to data at the data sources are reflected in the buffer 221 until that data can be committed to the core 211.

As illustrated, a data source (e.g., DSA 150) presents to the metadirectory 102 change data that represents changes to an external entity (e.g., external entity 250) stored within the data source. The change data may indicate that information about an object within the data source has changed in some fashion, or perhaps the change data indicates that its corresponding object has been deleted or added. A buffer entity (e.g., buffer entity 260) is first created using the change data to create an entity that represents the external entity (e.g., external entity 250) at the data source (e.g., DSA 150). Essentially, the buffer entity 260 mirrors its corresponding external entity 250. Other data sources (not shown) may also be presenting their own change data to the buffer 221 as well. The change data may sometimes be referred to as “delta information” or “deltas.”

As used in this document, the term “namespace” means any set of entities. The entities in a namespace may be unordered. Accordingly the term namespace may be used to refer to any set of entities, such as the core 211 or the buffer 221 (i.e., a core namespace or a buffer namespace). Or the term namespace may be used to refer collectively to the metadirectory 102 as a namespace. Similarly, any of the data sources may sometimes be referred to as namespaces.

A process termed synchronization occurs to reconcile the buffer entities in the buffer 221 with their corresponding core entities in the core 211. For instance, in this example buffer entity 260 is associated with core entity 270. Through the synchronization process, modifications represented in the buffer entity 260, as well as perhaps other buffer entities, become reflected in the core entity 270. By creating this synchronized relationship between the buffer 221 and the core 211, a pair of namespaces (e.g., a buffer namespace and a core namespace) may be referred to as “correlated namespaces.”

The synchronization process may also result in the creation or modification of other buffer entities (e.g., buffer entity 265) that represent changes to be made to objects in other data sources. The changes harmonize the information stored in the metadirectory 102 with the information stored in each of the data sources. In other words, a change to an object in data source DSA 150 may first be reflected in the metadirectory 102, but then that change may be pushed out of the metadirectory 102 to other data sources, such as to data source DSB 160 through buffer entity 265.

FIG. 3 is a functional block diagram generally illustrating information that is included in an “entity” 310 as that term is used in this document. The entity 310 includes a name (e.g., name 311), which preferably has a string value 321 unique across a particular namespace. The name is not permanent and can change at any time. Certain mechanisms and techniques described in this document are particularly well suited to addressing problems that arise when the name of one entity changes and another entities refer to that entity by name.

Each entity also includes an “identity” (e.g., identity 312), which is preferably a string value 322 that is globally unique. The identity of an entity does not change, i.e. it is an immutable property of the entity 310. In one example, the identity may be a Globally Unique IDentifier (“GUID”).

The use of both a name and a unique identifier may at first appear redundant, but each has a special purpose. For example, a human-readable name is intuitive and may be used to reflect a real-world property or concept, thus making the name very useful to users. However, this usability typically means that the name should also be changeable. In contrast, a globally unique identifier conveys little in terms of readability or intuitive message. It does however, effectively distinguish the entity from every other entity in existence.

The entity 310 includes an arbitrary number of reference attributes (e.g., reference attribute 313) that contain name/identity pairs 323 of other entities within the same namespace referred to by the referring entity. The reference attribute 313 can be used to create a loose association between entities when that information is helpful. For example, several entities may relate to individuals, and the reference attribute of one entity could be used to point to another entity that represents the manager of the individual represented by the first entity. The reference attribute 313 may have a single reference pair, or it may include multiple reference pairs, such as a distribution list. The reference attributes allow the modeling of arbitrary, directed relationships between entities.

The entity 310 may also include an arbitrary number of user data attributes (e.g., data_{—}1 314 and data_{—}2 315) that contain user data (e.g., user info 324 and 325, respectively). The user data attributes are helpful for storing random information that may be useful to the user or to the systems administering the entity or data sources. Of course, still other attributes may be included that are not described here without departing from the spirit of this disclosure.

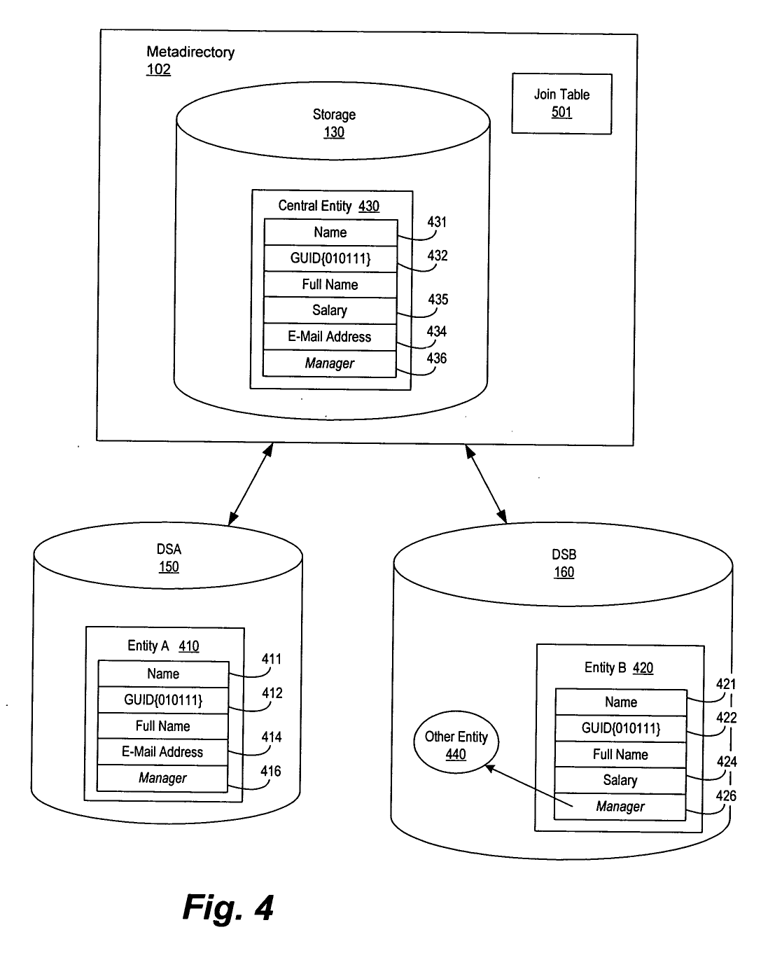

FIG. 4 is a functional block diagram generally illustrating a pair of entities each stored in a different data source, and their corresponding central entity stored in the metadirectory 102. Illustrated are a family of related entities, entity A 410, entity B 411, and central entity 412. Note that each entity has a name (i.e., Name 411, Name 421, Name 431) and an identity (i.e., Identity 412, Identity 422, Identity 432). Note that each entity could (but need not) have the same name because each is in a different namespace, but each entity has a unique identity.

The relationship between the entities is basically that entity A 410 and entity B 411 essentially represent the same body of information, and central entity 430 is an aggregated representation of those two entities. As discussed above, that could mean that both entity A 410 and entity B 411 relate to the same individual, corporate asset, e-mailing list, or any other body of information. In that case, central entity 430 could then be a common view into the information contained within each of those entities. The relationships between entities in the metadirectory 102 may be described in a persistent fashion (in this example) in a “join table” 501 or other comparable structure. One embodiment of the join table 501 is described below in conjunction with FIG. 5. Briefly described, the join table 501 contains data that correlates each central entity in the metadirectory 102 with one or more external entities (e.g., entity A 410 and entity B 420) from which the central entity derives its data.

It is not imperative that each of the entities refer to the same body of information, but it simplifies this discussion. It will become apparent how the mechanisms and techniques described here have equal applicability in the alternative case where each entity does not refer to the same body of information.

Note that the several entities need not include identical information. For example, entity A 410 includes an e-mail address 414 while entity B 420 does not. Similarly, entity A 410 does not include salary information while entity B 420 does (salary 425). However, the central representation (i.e., central entity 430) includes all the data from each of its associated entities (e.g., entity A 410 and entity B 420). Note that central entity 430 includes both an e-mail address 434 and a salary 435.

In addition, for no particular reason, the two entities may have the same information possibly formatted differently. For example, entity A 410 may identify a manager 416 of an individual with which the entity is associated, and entity B 420 may also. However, the manager 416 of entity A 410 may be identified by name, while the manager 426 of entity B 420 may be identified by e-mail address.

It will be appreciated that different attributes of the entities may be “mastered” in different locations. In other words, if multiple entities (e.g., entity A 410 and entity B 420) represent a similar attribute (e.g., both entities have a “manager”), then the value of that attribute may be governed by a master entity. For example, if entity A 410 is defined as the master of the “manager” attribute, then the value of the manager 436 in the metadirectory 102 should always be taken from entity A 410. Similarly, when harmonizing the information in each of the data sources, it is envisioned that entity B 420 will get its value for the manager 426 from the metadirectory 102, thus ensuring that only one data source governs the value of particular attributes.

The described system includes a particular mechanism that is especially well suited to establishing these governing master/slave relationships between entities in the form of a graphical user interface. One example of that graphical user interface is described below in conjunction with FIGS. 6 and 7.

As described above, each entity may include reference attributes that refer to other entities. In this way, one entity may essentially incorporate the information of another entity in a simplified way. For example, as illustrated in FIG. 4, the manager 426 of entity B 420 may in fact be a reference attribute that includes information that identifies another entity (other entity 440), and that other entity 440 represents the manager. This redirection basically allows a much greater spectrum of information to be identified within a single attribute (e.g., the manager 426). However, reference attributes pose a particular problem when harmonizing the information among the several data sources because of the possibility that entities may have different names, have information formatted differently, or in general that there may not be a direct correlation between information for attributes in one namespace (e.g., DSA 150) and another (e.g., DSB 160). The mechanisms and techniques described in this document are particularly well suited to overcoming those problems.

FIG. 5 is a graphical representation of one illustrative join table 501 that may be included in some implementations of the present invention. As mentioned, the join table 501 is one example of how the metadirectory 102 can maintain information about relationships between entities in the metadirectory 102 and entities in the different data sources. More specifically, the join table 501 correlates entities in each associated data source with its central representation in the metadirectory 102. In other words, each entity in the metadirectory 102 includes a record in the join table 501 that identifies which external entity provides the central entity with information.

In this embodiment, the join table 501 includes two sets of information: a first set 510 that includes at least one record for each entity in the metadirectory 102, and a second set 520 that identifies each entity with which the central entities are associated. Each record in the first set 510 includes at least the identity of a corresponding central entity. Each record in the first set 510 may also include the name of the corresponding central entity. Each record in the second set 520 also includes at least the identity of its corresponding external entity, and may also include its name.

Mappings are provided that link each record in the first set 510 with the records in the second set 520. So as illustrated in FIG. 5, the central entity having the identity of “10” is associated with the external entity having the identity of “67.” Note that because one central entity may be associated with multiple external entities, there may be multiple records for a particular central entity with each record defining a different relationship. For example, the central entity having the identity of “30” is associated with two external entities having the identities of “93” and “72.” Alternatively, it should be apparent that a single record could simply include multiple entries in the second set 520. However, the fundamental concept here is that given a particular identity for a central entity, the identity of any corresponding external entities can be discovered. Similarly, given a particular identity for an external entity, the identity of any corresponding central entity can be discovered.

It should also be noted that although the use of identities (as immutable 19 properties of entities) has been described here, a less robust system could be achieved through the use of names as the describing characteristic.

FIGS. 6 and 7 are illustrative screen shots illustrating a graphical user interface 600 that may be employed to create rules to govern the master/slave relationships described in conjunction with FIG. 4. As described above, harmonizing the data stored in each of the entities associated with the system may be thought of as a two step process. First, changes to information (e.g., modifications to an entity) in a data source are passed to and become reflected in the metadirectory 102. Then those changes are pushed out to other data sources that are interested in the changed information. Accordingly, FIG. 6 illustrates the creation of a rule that governs the first part of the process, namely data being brought into the metadirectory 102. And FIG. 7 illustrates the creation of a rule that governs the second part of the process, namely data being pushed out of the metadirectory 102.

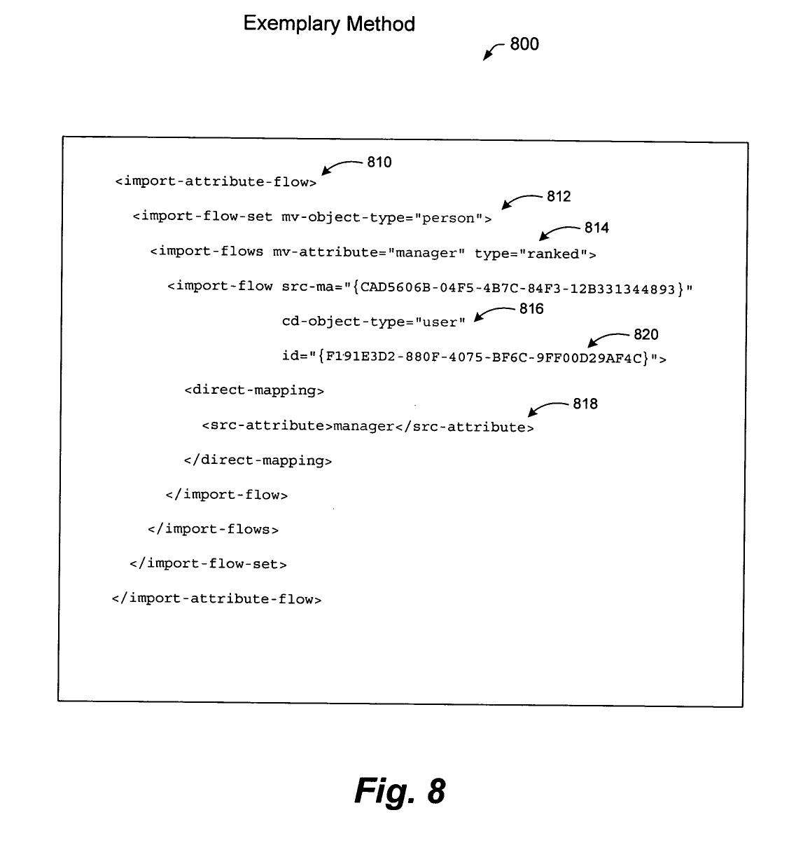

Referring first to FIG. 6, the user interface 600 may be invoked by a user of the metadirectory 102 to configure master/slave relationships for entities in the metadirectory 102. The user interface 600 involves the creation of a “Management Agent” that is essentially a set of rules associated with a particular data source and that governs the flow of data between the metadirectory and the associated data source. The resultant rules, in one embodiment, may be expressed in eXtensible Markup Language (XML) as a configuration file associated with the particular data source. FIG. 8, described below, illustrates some illustrative XML code that may be generated by the user interface 600.

The user interface 600 includes a flow direction portion 610 to indicate whether the rule being created governs the import or export of data into or out of (respectively) the metadirectory. The import option is selected in FIG. 6, indicating that the particular rule being created governs the import of data. Selecting the import option serves the purpose of identifying the associated data source (or entity) as the master.

A data source attribute portion 612 and a metaverse attribute portion 614 present the user with options to select which particular attributes are being affected. In other words, the master/slave relationships for an entity are defined (in this example) on a per-attribute basis. Thus, the selections illustrated in FIG. 6 demonstrate that a “manager” attribute for an entity in the associated data source is imported and governs the value of the “manager” attribute for an entity in the metadirectory. A visual representation 616 may also be presented to graphically illustrate to the user that the value for the manager attribute flows from the data source to the metaverse in the metadirectory.

It should be noted that the user interface 600 is being used to create a rule that governs the flow of data for groups of entities that satisfy a particular entity or object “type.” This implementation detail avoids the need to create a separate rule to control every entity in the metadirectory 102. Thus, each entity may be assigned a particular “type” or “class” and its corresponding attributes would then be governed by the rule created for that particular type or class of entity.

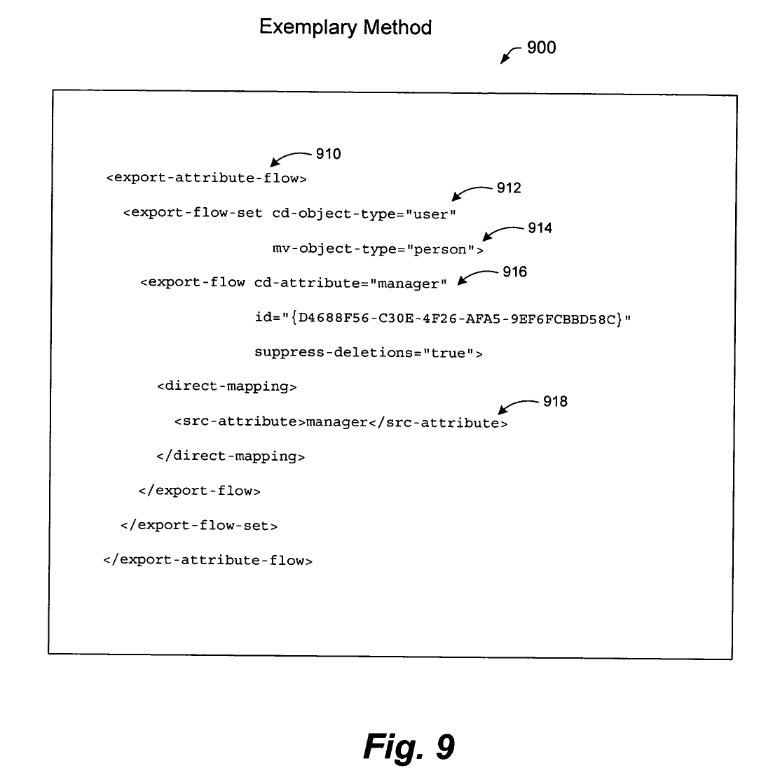

Referring now to FIG. 7, a similar user interface 700 illustrates the creation of another Management Agent associated with another data source (i.e., a data source different from the one being configured by the user interface 600 of FIG. 6). The user interface 700 also includes a flow direction portion 710 to indicate whether the rule being created governs the import or export of data. In this embodiment, the export option is selected to indicate that data flows out of the metadirectory and into the associated data source. Selecting the export option serves the purpose of indicating that the associated data source is the slave. Again, a data source attribute portion 712 and a metaverse attribute portion 714 present the user with selections for the particular attributes being governed. FIG. 9, described below, illustrates some illustrative XML code that may be generated by the user interface 700.

FIG. 8 is a sample of XML code 800 that may be generated by the user interface 600 of FIG. 6. As illustrated, an “import-attribute-flow” tag 810 indicates that the rule governs the import of data into the metadirectory. A second tag 812 identifies the entity (or entity type) within the metadirectory that is affected. A third tag 814 identifies the particular attribute that is being mastered (“manager” in this example). A fourth tag 820 includes a unique identifier that identifies the particular data source that provides the data for the “manager” attribute, and a fifth tag 816 indicates that the entities in that data source of type “user” are the master. A sixth tag 818 identifies the “manager” attribute as the particular attribute of the external entity that provides the data.

FIG. 9 is a sample of XML code 900 that may be generated by the user interface 700 of FIG. 7. As illustrated, an “export-attribute-flow” tag 910 indicates that the rule governs the export of data from the metadirectory out to an external data source. A second tag 912 identifies the entity (or entity type) within the external data source that is affected. A third tag 814 identifies the entity (or entity type) within the metadirectory that provides the data for export. A fourth tag 816 identifies the particular attribute (“manager” in this example) of the external entity that receives its data from the metadirectory. A fifth tag 818 identifies the particular attribute of the entity within the metadirectory that provides the data.

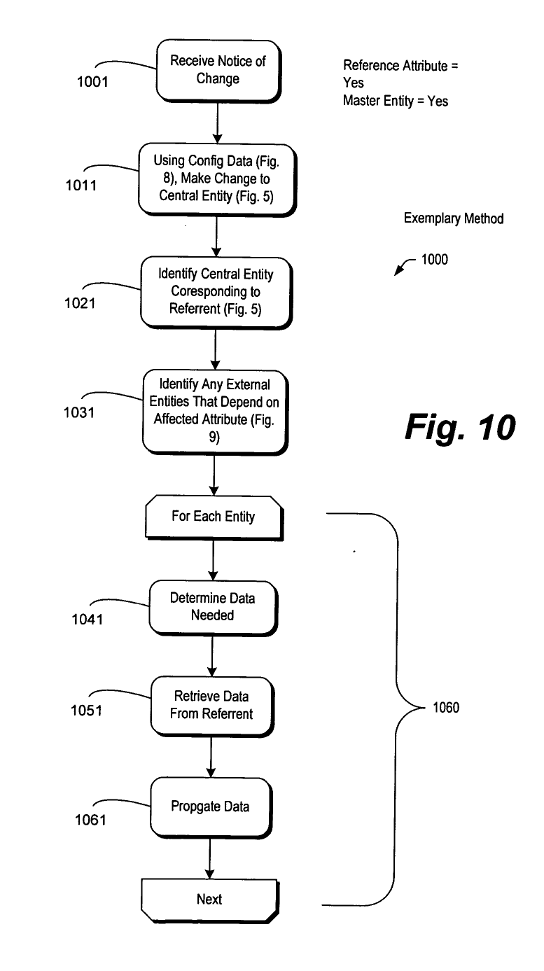

FIG. 10 is a logical flow diagram generally illustrating steps performed by a process 1000 for propagating a change to a reference attribute in one data source to another data source in a metadirectory environment. This process focuses on propagating changes to a reference attribute in an external entity as compared to a common attribute. Because reference attributes point to other entities, the referential information in one data source may be unusable in the other data sources. Accordingly, the process 1000 of FIG. 10 is directed at propagating the information affected by a change to a referential entity in one data source to other data sources in whatever form the other data sources desire or require

The process 1000 begins at starting step 1001, where a metadirectory receives notice of a change to an attribute of an external entity. For the purpose of this discussion, it will be assumed that the change affects a reference attribute, and that the entity issuing the change is the master of the attribute (or belongs to the data source which is designated as the master of the attribute). The entity issuing the change will be termed the “master entity,” and the entity being referred to by the change to the reference attribute is termed the “referent.”

At block 1011, the process 1000 applies the change to the central entity that corresponds to the master entity. Using the join table 501 (FIG. 5), the process 1000 is able to identify the central entity that corresponds to the master entity by looking up the index (i.e., the identity in this embodiment) for the master entity and correlating that entry in the join table 501 with its corresponding central entity record. Once identified, the process 1000 applies the change to the central entity. However, making the change to the central entity corresponding to the master entity is not enough to propagate the change. Other external entities may have attributes that depend on the value associated with the new referent of the master entity. Thus, the process 1000 continues at block 1021.

At block 1021, the central entity corresponding to the referent is identified (hereafter referred to as the central referent). Again, referring to the join table 501 and using the identity of the referent, the central referent is discovered. Recall that the value of a reference attribute is an identity/name pair. Thus, the central referent is easily identified by determining from the join table 501 which central entity correlates to the identity of the referent.

At block 1031, any external entities that depend on the affected attribute are discovered. In this embodiment, this may be achieved by referring to any configuration files (see FIG. 9) for each data source in the system to which the affected data is exported. Any entities that are registered as having attributes mastered by the central entity may be identified. At that point the process 1000 enters a loop 1060 for each identified external entity.

At block 1041, the particular character of data for the attribute is discovered be evaluating the affected external entity. For example, if the affected attribute of the master entity identifies (refers to) an employee's manager, it is possible that a different external entity may have an attribute that identifies that employee's manager but perhaps by e-mail alias rather than by reference. In this case, the particular data of interest is the e-mail alias of the manager and not a reference to the manager. Accordingly, at block 1041, the process determines the particular format of the data for the current external entity. The format, as used here, of the data may also mean a value from a different attribute of the central referent, such as a user data attribute, or the like.

At block 1051, the particular data needed for the current external entity is retrieved from the central referent, and, at block 1061 that data is propagated to the current external entity. Once this step is performed, the process loops 1060 until all affected external entities have been addressed.

It should be noted that the change to the reference attribute may have been caused by a change on the referent entity which modified the name of that entity. In other words, the reference attribute may continue to point to the same referent, but by a different name. The system described here includes techniques to address propagating that change as well.

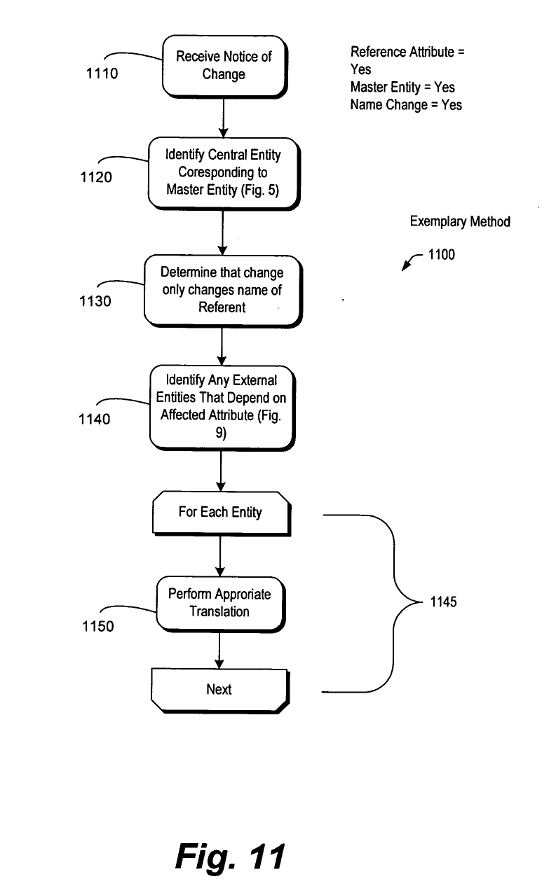

FIG. 11 is a logical flow diagram generally illustrating steps of a process 1100 for propagating a name change of a referent in a reference attribute. The process 1100 begins at block 1110, where a metadirectory receives notice of a change to a reference attribute of an external entity. In this embodiment, the change affects the name of the referent but not the identity of the referent. Again, the entity issuing the change will be termed the “master entity.”

At block 1120, the process 1100 identifies and retrieves the central entity that correlates to the master entity. This step may be achieved with reference to the join table 501 (FIG. 5) by looking up the identity of the master entity and identifying its correlated central entity.

At block 1130, the process 1100 determines that the change reflects only a name change of the referent. This may be achieved by comparing the change data from the master entity with the stored data in the central entity. Because the current system identifies entities by both identity (immutable) and name (mutable), the process 1000 can merely determine if the identities are the same between the data stored in the central entity and the change data. If so, then the change is only a name change.

At block 1140, the process 1140 identifies other external entities that depend on the referent. For the purpose of this discussion, the term “depends on” means that some data or attribute value of the external entity is derived from data or attribute values of the referent. This identification can be performed by simply querying the join table 501 for the identity of the referent (which has not changed) even though the name has changed. This ability is one of the benefits of persisting the immutable identity information to correlate entities in the metadirectory with external entities.

At block 1150, an appropriate translation occurs to alter the dependant data of the identified external entities to reflect the name change of the referent. It should be noted that the particular fashion in which the external entity depends on the name of the referent controls the form of the transformation. In other words, it is impossible to determine in advance exactly how other external entity will depend on a referent, and accordingly, the particular transformation applied will be based on the particular manner of dependency. The process 1100 may loop (1145) until all affected entities have been processed.

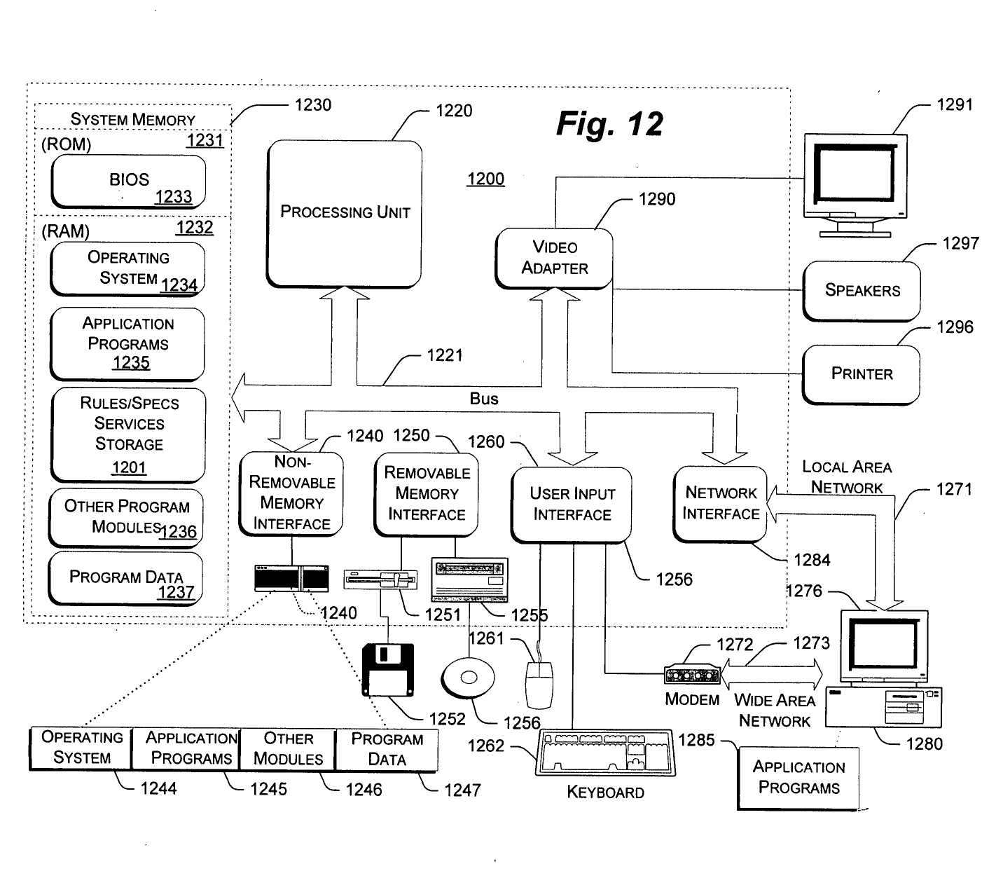

FIG. 12 shows an exemplary computer 1200 suitable as an environment for practicing various aspects of subject matter disclosed herein. Components of computer 1200 may include, but are not limited to, a processing unit 1220, a system memory 1230, and a system bus 1221 that couples various system components including the system memory 1230 to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISAA) bus, Video Electronics Standards Association (VESA) local bus, and Peripheral Component Interconnect (PCI) bus also known as the Mezzanine bus.

Exemplary computer 1200 typically includes a variety of computer-readable media. Computer-readable media can be any available media that can be accessed by computer 1200 and includes both volatile and nonvolatile media, removable and non-removable media. By way of example, and not limitation, computer-readable media may comprise computer storage media and communication media. Computer storage media include volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1200. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 1230 includes computer storage media in the form of volatile and/or nonvolatile memory such as read only memory (ROM) 1231 and random access memory (RAM) 1232. A basic input/output system 1233 (BIOS), containing the basic routines that help to transfer information between elements within computer 1200, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, the exemplary rules/specifications, services, storage 1201 (e.g., storage may occur in RAM or other memory), application programs 1235, other program modules 1236, and program data 1237. Although the exemplary rules/specifications, services and/or storage 1201 are depicted as software in random access memory 1232, other implementations may include hardware or combinations of software and hardware.

The exemplary computer 1200 may also include other removable/non-removable, volatile/nonvolatile computer storage media. By way of example only, FIG. 12 illustrates a hard disk drive 1241 that reads from or writes to non-removable, nonvolatile magnetic media, a magnetic disk drive 1251 that reads from or writes to a removable, nonvolatile magnetic disk 1252, and an optical disk drive 1255 that reads from or writes to a removable, nonvolatile optical disk 1256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface such as interface 1250.

The drives and their associated computer storage media discussed above and illustrated in FIG. 12 provide storage of computer-readable instructions, data structures, program modules, and other data for computer 1200. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237. Operating system 1244, application programs 1245, other program modules 1246, and program data 0.1247 are given different numbers here to illustrate that, at a minimum, they are different copies. A user may enter commands and information into the exemplary computer 1200 through input devices such as a keyboard 1262 and pointing device 1261, commonly referred to as a mouse, trackball, or touch pad. Other input devices (not shown) may include a microphone, joystick, game pad, satellite dish, scanner, or the like. These and other input devices are often connected to the processing unit 1220 through a user input interface 1260 that is coupled to the system bus, but may be connected by other interface and bus structures, such as a parallel port, game port, or a universal serial bus (USB). A monitor 1291 or other type of display device is also connected to the system bus 1221 via an interface, such as a video interface 1290. In addition to the monitor 1291, computers may also include other peripheral output devices such as speakers 1297 and printer 1296, which may be connected through an output peripheral interface 1295.

The exemplary computer 1200 may operate in a networked environment using logical connections to one or more remote computers, such as a remote computer 1280. The remote computer 1280 may be a personal computer, a server, a router, a network PC, a peer device or other common network node, and typically includes many or all of the elements described above relative to computer 1200, although only a memory storage device 1281 has been illustrated in FIG. 12. The logical connections depicted in FIG. 12 include a local area network (LAN) 1271 and a wide area network (WAN) 1273, but may also include other networks. Such networking environments are commonplace in offices, enterprise-wide computer networks, intranets, and the Internet.

When used in a LAN networking environment, the exemplary computer 1200 is connected to the LAN 1271 through a network interface or adapter 1270. When used in a WAN networking environment, the exemplary computer 1200 typically includes a modem 1272 or other means for establishing communications over the WAN 1273, such as the Internet. The modem 1272, which may be internal or external, may be connected to the system bus 1221 via the user input interface 1260, or other appropriate mechanism. In a networked environment, program modules depicted relative to the exemplary computer 1200, or portions thereof, may be stored in the remote memory storage device. By way of example, and not limitation, FIG. 12 illustrates remote application programs 1285 as residing on memory device 1281. It will be appreciated that the network connections shown are exemplary and other means of establishing a communications link between the computers may be used.

The subject matter described above can be implemented in hardware, in software, or in both hardware and software. In certain implementations, the exemplary flexible rules, identity information management processes, engines, and related methods may be described in the general context of computer-executable instructions, such as program modules, being executed by a computer. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A computer-executable method, comprising:
receiving an indication of a change to an attribute of a first external object in a first namespace, the change including a reference to a second external object in the first namespace;
identifying a first central object in a second namespace, the first central object corresponding to the first external object in the first namespace;
identifying a second central object in the second namespace that corresponds to the second external object in the first namespace;
identifying another external object that depends on data stored in association with the second central object in the second namespace; and
propagating the data to the other external object.

2. The method recited in claim 1, wherein the indication of a change comprises a notice that the reference to the second external object was added, modified, or deleted.

3. The method recited in claim 1, wherein identifying the first central object in the second namespace comprises evaluating correlation information that correlates objects in the first namespace with objects in the second namespace.

4. The method recited in claim 3, wherein the correlation information comprises a persistent data store that associates central objects in the second namespace with external objects in other namespaces.

5. The method recited in claim 4, wherein the association comprises a link between a unique identifier for each central object in the second namespace and unique identifies for each external object.

6. The method recited in claim 5, wherein the unique identifier comprises a globally unique identifier.

7. The method recited in claim 4, wherein the persistent data store comprises a table.

8. The method recited in claim 1, wherein the second namespace comprises a metadirectory.

9. The method recited in claim 1, wherein each object comprises an entity.

10. The method recited in claim 9, wherein each entity comprises a unique identifier that is immutable and a name.

11. The method recited in claim 10, wherein the name is mutable.

12. A computer-readable medium having computer-executable instructions for performing the method recited in claim 1.

13. A computer-executable method, comprising:
propagating a reference change from a first object in a first namespace to a related second object in another namespace by:
correlating the first object to a central representation of the first object;
identifying another central representation corresponding to a referent of the reference;
identifying another object in the other namespace, the other object being associated with the other central representation and depending on data stored in association with the other central representation; and
providing the data to the object.

14. The method recited in claim 13, wherein the data is formatted in accordance with the other object.

15. The method recited in claim 13, wherein the first object and the other object comprise entities having an immutable characteristic.

16. The method recited in claim 15, wherein the immutable characteristic comprises a globally unique identifier.

17. The method recited in claim 15, wherein correlating the first object to the central representation comprises identifying a link between the immutable characteristic of the first object and the central representation.

18. The method recited in claim 17, wherein identifying the other object in the other namespace comprises identifying a second link between an immutable characteristic of the other object and the other central representation.

19. The method recited in claim 13, wherein the central representation comprises an aggregation of information from the first object and the other object.

20. The method recited in claim 13, wherein the central representation and the other central representation reside in a metadirectory.

21. A computer-readable medium having computer-executable instructions for performing the method of claim 13.

22. A computer-executable method, comprising
propagating a name change of a referent in a reference field of a first object in a first namespace to a related second object in a second namespace by:
correlating the referent to a central representation of the referent:
identifying another object associated with the central representation; and
propagating the name change to the other object.

23. The method recited in claim 22, wherein correlating the referent to the central representation is performed using an immutable property of the referent.

24. The method recited in claim 23, wherein the immutable property of the referent comprises a globally unique identifier.

25. The method recited in claim 23, wherein the immutable property of the referent is persisted as correlation information.

26. A computer-readable medium having computer executable components comprising:
a system that propagates a change to a reference in a first object in one external namespace, wherein the reference refers to a second object in the one external namespace, the first object and the second object each having an associated central representation in a central namespace, the change being propagated by a component configured to evaluate an association between the central representation of the second object and the second object in the one external namespace to identify a third object in a second external namespace, the component being further configured to pass the data to the third object.

27. The computer-readable medium of claim 26, wherein the component is further configured to evaluate the association between the central representation of the second object and the second object by identifying a link between an immutable characteristic of the second object and an immutable characteristic of the central representation.

28. The computer-readable medium of claim 27, wherein the component is further configured identify the third object in the second external namespace by identifying a link between an immutable characteristic of central representation and an immutable characteristic of the third object.

29. The computer-readable medium of claim 28, wherein the immutable characteristics comprise globally unique identifiers.

30. A computer-readable medium having computer-executable components, comprising:
A graphical user interface for creating a configuration file, the user interface including:
a first area for identifying a central attribute, the central attribute residing within a central entity;
a second area for identifying an external attribute, the external attribute residing within an external entity, the central entity and the external entity being correlated; and
a third area for identifying a direction of flow of data between the central attribute and the external attribute.

31. The computer-readable medium of claim 30, wherein the third area comprises at least two options, an option to flow the data from the external entity to the central entity or to flow the data from the central entity to the external entity.

32. The computer-readable medium of claim 30, wherein the user interface is further configured to generate a configuration file embodying information provided by a user of the user interface, the information being based on a selection of the direction of flow of data and the identified central and external attributes.

33. The computer-readable medium of claim 32, wherein the configuration file comprises an extensible markup language file.
